(19) United States
(12) Patent Application Publication
(10) Pub. No.: US 2008/0227555 A1
(43) Pub. Date: Sep. 18, 2008

(54) Yoke With Integral Bridge and Hub

(76) Inventor: Daryl J. Jaeger, Kewaskum, WI (US)

Correspondence Address: QUARLES & BRADY LLP, 411 E. WISCONSIN AVENUE, SUITE 2040, MILWAUKEE, WI, 53202-4497, US

(21) Appl. No.: 11/915,211

(22) PCT Filed: May 17, 2006
(86) PCT No.: PCT/US2006/018975

§ 371 Date: Nov. 21, 2007

Related U.S. Application Data
(60) Provisional application No. 60/684,640, filed on May 25, 2005.

(51) Int. Cl. F16D 3/16

(52) U.S. Cl. 464/134

(57) ABSTRACT

A yoke for a universal joint has the hub, main portion including arms and the bridge made in one monolithic piece, without welds.

### CROSS-REFERENCE TO RELATED APPLICATION

This application claims the benefit of U.S. Provisional Patent Application No. 60/684,640 filed 25 May 2005.

### STATEMENT CONCERNING FEDERALLY SPONSORED RESEARCH OR DEVELOPMENT

Not applicable.

### FIELD OF THE INVENTION

This invention relates to universal joints, and in particular to yokes for universal joints.

### BACKGROUND OF THE INVENTION

Universal joints and yokes for them are well-known. Typically, a constant velocity universal joint has two yokes which are each connected by a cross member to a center housing. There is usually provided a centering apparatus between the two yokes so that as they angulate, their shaft axes equally bisect the angle of angulation.

Yokes for universal joints have typically been made in at least two pieces, and then the two pieces welded together. Each yoke has a main part with two arms in which two legs of the cross member are journaled, either by a journal bearing, a ball bearing or another type of anti-friction bearing. A bridge at the housing end of the two legs spans the two legs and usually mounts either a ball or a socket. At the other, or shaft, end of the main portion, a hub is provided that has an internal shape to be slid axially onto a shaft to be connected, with relative rotary motion between the hub and the shaft restrained, for example a spline connection, a key connection or another shaped connection that prevents rotation between the hub and the shaft.

Typically, either the bridge has been made separate from the main portion and the hub made in one piece with the main portion, or the bridge has been made in one piece with the main portion and the hub made separate from the main portion. These manufacturing methods required the at least two parts to be welded together, resulting in material and process inefficiencies.

### SUMMARY OF THE INVENTION

The present invention provides a yoke in which the hub, main portion and bridge are made in one piece, with no welding or other fastening processes required to join them.

The hub may be formed with any type of shaft opening that is formed to mate with the shaft that the yoke connects with a connection that prevents rotation between the shaft and the yoke. Examples are splines, a key connection, or any other shaped connection in which the hub portion of the yoke can be slid onto a shaft axially with rotation between the yoke and the shaft restrained.

The yoke may be made in one piece, meaning that there is no welding or other fastening processes required to join the hub, main portion and bridge. In other words, the hub, main portion and bridge are monolithic.

Manufacturing processes that may be used to make a yoke of the invention include shaper cutting, blind broaching, punching, CNC profiling, sintered metal casting and other powder metal manufacturing processes. Forming the hub, main portion and bridge together, monolithically in a single operation, avoids having to fasten them together and also creates a very structurally sound component.

These and other advantages of the invention will be apparent from the detailed description and drawings.

### BRIEF DESCRIPTION OF THE DRAWINGS

FIG. 1 is a prior art yoke of the invention in which a bridge portion is welded to the main portion and has a ball extension;

FIG. 2 is an end plan view of the yoke of FIG. 1;

FIG. 3 is a view like FIG. 1 in which the bridge portion is welded to the main portion but in which a socket extends from the bridge portion;

FIG. 4 is a view of a prior art yoke in which the bridge portion is made in one piece, or monolithically, with the main portion and the hub made as a separate piece and welded to the rear end of the main portion;

FIG. 5 is a perspective view of the yoke of the invention having a ball extending from the bridge; and

FIG. 6 is a perspective view of a yoke of the invention having a socket extending from the bridge and with a differently-shaped hub opening than the yoke of FIG. 5.

### DETAILED DESCRIPTION OF THE PREFERRED EMBODIMENT

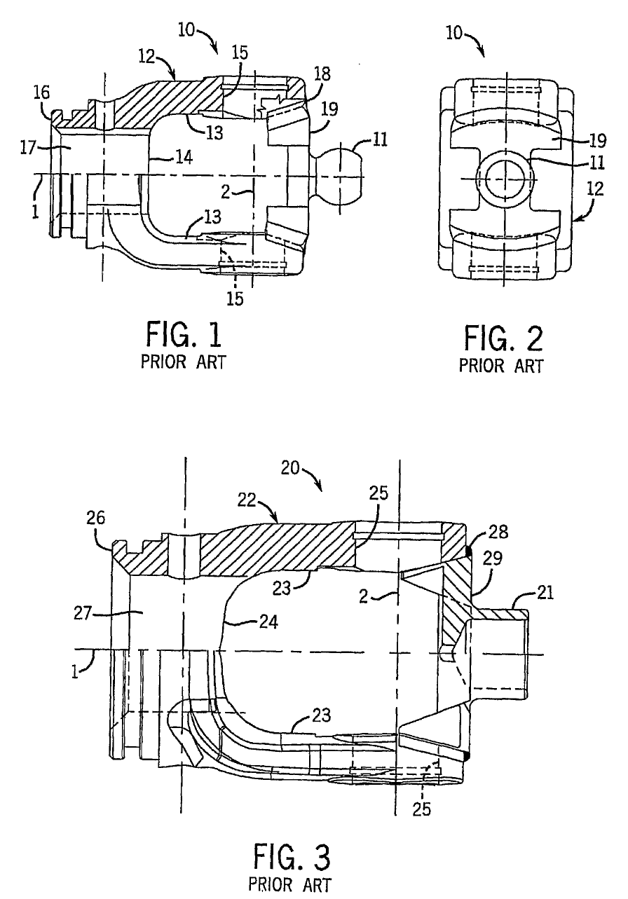

FIGS. 1-4 illustrate prior art universal joints 10, 20 and 30, each having a main portion 12, 22 and 32, respectively. Each main portion has a pair of laterally spaced apart arms 13, 23 or 33, respectively, which are joined at the rear ends by a respective web 14, 24 or 34. Each of the arms 13, 23 and 33 has a respective hole 15, 25 or 35 with axes along radial line 2 in which two opposite arms of a cross link or cross member (not shown) are journaled by a bushing or other anti-friction bearing such as a ball bearing, sleeve bearing, etc. In the embodiments of FIGS. 1-3, at the rear end of the web 14, 24 and integral with the web 14, 24, a hub 16 or 26 is formed having an opening 17 or 27 that is shaped with a spline, key, or other non-round-shaped cross section so that a shaft of a similar mating shape can be slid into the opening along shaft axis 1 and the hub fixed by the mating opening 17 or 27 to the shaft so that the yoke 10 or 20 does not rotate relative to the shaft but is axially slidable thereon.

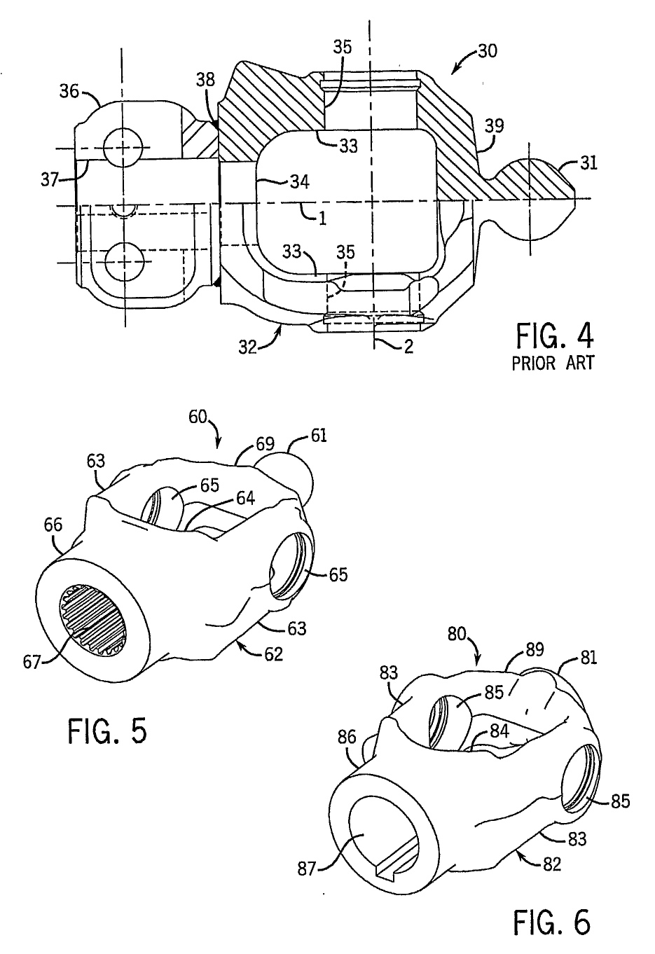

In the embodiment 30 of FIG. 4, the hub 36 has a similar opening 37 and is made as a separate part and welded onto the web 34 of the main portion 32 at the interface 38, coaxial with the longitudinal axis 1. In the embodiment 30, at the front end of the arms 33, a bridge 39 is formed integral with the front ends of the arms 33, and a ball 31 extends from the middle of the bridge 39.

In the embodiments 10 and 20, the respective bridge 19 or 29 is made as a separate piece and welded on at 18 or 28 respectively. A ball 11 extends from the bridge 19 and a socket 21 extends from the bridge 29 in which the ball 11 may be received when the two yokes are put together by journaling them with cross links to a center housing.

FIGS. 5 and 6 illustrate respective yokes 60 and 80 of the invention, which are formed with the hub, main portion and bridge all in one piece, so that those three parts are monolithic with one another. In each of the embodiments 60 and 80, similar parts are labeled with the same reference number, as in the FIG. 1 embodiment for the yoke 60, plus 50, and as the FIG. 3 embodiment for yoke 80, plus 60.

In the yokes 60 and 80, the main portions 62, 82 are one piece and integral with each respective bridge 69, 89 and each respective hub 66, 86.

The yokes 60 and 80 can be made by various manufacturing methods including casting to rough form and then shaper cutting, blind broaching, forging, punching, CNC profiling or sintered powdered metal processes either combined with forging or not. Other manufacturing processes such as other powder metal processes or other processes could also possibly be used.

The yokes 60, 80 can be made with any number of shapes of the shaft opening 67, 87, only two of which are shown in FIGS. 5 and 6. The splines, such as shown in FIG. 5, may be fine or coarse, one or more keyways, such as shown in FIG. 6 (only one keyway illustrated) may be used, and different shapes which are non-circular may be used for the opening 87 so that the yoke can be slid onto a shaft coaxially therewith but not rotatable relative to the shaft.

Preferred embodiments of the invention have been described in considerable detail. Many modifications and variations to the preferred embodiments described will be apparent to those skilled in the art. Therefore the invention should not be limited to the embodiments described, but should be defined by the claims which follow.

1. In a universal joint yoke of a type that has a hub with a longitudinal opening through it for slidable non-rotary connection to a shaft coaxial with the shaft, a main portion having two opposed arms spaced radially in which a cross link of the universal joint may be journaled, and a bridge that joins ends of the arms opposite from the hub, the improvement wherein the hub, the main portion and the bridge are integral with one another in one monolithic piece without welds holding the hub, main portion and bridge together.

2. The improvement of claim 1, wherein the bridge has a ball extending from it.

3. The improvement of claim 1, wherein the bridge has a socket extending from it.

4. The improvement of claim 1, wherein the opening through the hub is splined.

5. The improvement of claim 1, wherein the opening through the hub has a keyway formed in it.
